(19) United States
(12) Patent Application Publication
(10) Pub. No.: US 2026/0285657 A1
(43) Pub. Date: Sep. 24, 2026

(54) TRAILER OPERATIONS SAFETY SYSTEM

(71) Applicant: Gideon Brothers d.o.o., Osijek (HR)

(72) Inventors: Edin Koco, Zagreb (HR); Jerko Starcevic, Rijeka (HR); Vedran Brkic, Zagreb (HR)

(21) Appl. No.: 19/083,656

(22) Filed: Mar. 19, 2025

(51) Int. Cl. B66F 9/06; B65G 67/02

(52) U.S. Cl. CPC B66F 9/063; B65G 67/02

(57) ABSTRACT

An autonomous mobile robot operates with an adaptive safety field to detect and respond to obstacles in its environment. When traversing toward a target zone that includes a confined space, the robot dynamically adjusts its safety mechanisms. In response to detecting an object within the safety field, the robot performs a remedial including reducing speed. To facilitate entry into a confined space, such as a trailer, the robot detects a marker positioned at the entrance, indicating authorization for entry. In response to detecting the marker, the robot deactivates its safety field, allowing it to disregard obstacles, including walls, enabling safe maneuvering in close proximity within the confined space. In response to determining that the robot has exited the confined space, the safety field is reactivated to restore obstacle detection and maintain the threshold of distance.

### TECHNICAL FIELD

This application relates to autonomous robots, more specifically to autonomous robots configured to operate safely at higher speeds in confined spaces.

### BACKGROUND

An autonomous mobile robot, such as an autonomous forklift, is a robot capable of autonomously navigating an environment (e.g., a warehouse) and manipulating objects within that environment. An autonomous mobile robot may use a 2D environment map for navigation within a warehouse. The environment map may contain information about objects and obstacles within the warehouse. For example, it may include details about the positions of objects, which the autonomous mobile robot can use when manipulating those objects.

Sometimes, an autonomous mobile robot needs to enter and operate in confined spaces, such as inside trailers for loading and unloading pallets. When a robot enters a confined space like a trailer to perform tasks, normal safety fields cannot be maintained. To enable the robot to maneuver and place pallets inside a trailer, safety fields are often required to be muted. Existing safety standards typically allow muting only when the robot operates below a maximum speed, such as no greater than 0.3 meters per second (m/s). However, this speed reduction is impractical for trailer operations due to the long distances the robot must travel inside the trailer, significantly decreasing operational efficiency.

### SUMMARY

Embodiments described herein address the above-described challenge by implementing safety features, including a removable marker at the entrance of a confined space (e.g., a trailer). The marker enables the autonomous robot to enter the confined space with its safety fields muted and to operate at a speed higher than the safety threshold of 0.3 m/s.

The autonomous robot has a safety field feature that, when activated, monitors a region around the robot to detect objects within its vicinity. In some embodiments, when the safety field feature is activated, the autonomous robot utilizes one or more sensors to monitor its surroundings. In response to detecting an object within the safety field while the autonomous robot traverses toward a target zone comprising a confined space, the autonomous robot performs a remedial action including reducing its speed. In some embodiments, the autonomous robot may stop, detour around the object, or generate an alert in response to detecting an object within the safety field.

The autonomous robot is also configured to detect whether there is a marker positioned at an entrance of a confined space (e.g., a trailer), indicating that the autonomous robot is authorized to enter the confined space.

In response to detecting the marker, the autonomous robot deactivates the safety field feature, such that the autonomous robot is able to operate in close proximity to a boundary of the confined space at a speed higher than a safety threshold.

Even though the safety field is deactivated, the autonomous robot tracks its locations inside the confined space, and determines whether it moves outside of the confined space. In response to determining that it moves outside of the confined space based on the tracked location, the autonomous robot reactivates the safety field feature. In some embodiments, in response to deactivating the marker (e.g., blocking the marker with an object), the autonomous robot is prevented from reentering into the confined space.

### BRIEF DESCRIPTION OF THE DRAWINGS

FIG. 1 illustrates an environment for operating an autonomous mobile robot using a central communication system, in accordance with some embodiments.

FIG. 2 illustrates exemplary modules and data stores used by a central communication system, in accordance with some embodiments.

FIG. 3 illustrates exemplary modules and data stores used by the autonomous mobile robot, in accordance with some embodiments.

FIG. 4 illustrates an example autonomous mobile robot navigating through a warehouse environment to a trailer, in accordance with some embodiments.

FIG. 5A illustrates an example autonomous mobile robot navigating toward a trailer, in accordance with some embodiments.

FIG. 5B illustrates an example autonomous mobile robot operating inside a trailer, in accordance with some embodiments.

FIGS. 6A and 6B illustrate examples of safety fields features of an autonomous robot, in accordance with one or more embodiments.

FIG. 7 illustrates an example embodiment of a trailer operations safety system, in accordance with one or more embodiments.

FIG. 8A illustrates an example safety field of an autonomous robot that may be dynamically reactivated during a loading or unloading operation, in accordance with one or more embodiments.

FIG. 8B illustrates an example safety field of an autonomous robot that may be dynamically reactivated during a side shift operation, in accordance with one or more embodiments.

FIG. 9 is a flowchart of an example method for efficiently operating an autonomous robot in a confined space, in accordance with one or more embodiments.

### DETAILED DESCRIPTION

Autonomous mobile robots may be used for load-handling tasks. To perform such tasks, these robots may be equipped with load-handling mechanisms. For instance, some autonomous mobile robots may include forks, which are used to lift, carry, and transport loads such as pallets, crates, or containers. However, the embodiments described herein are not limited to robots with forks. The same or similar principles can be implemented on robots with other end effectors or without end effectors.

In some cases, the robot needs to enter confined spaces to perform tasks, such as inside trailers for loading and unloading pallets, where normal safety fields cannot be maintained due to physical and operational constraints. To allow the robot to maneuver effectively in such confined spaces, safety fields are often muted. However, existing safety standards permit muting only when the robot operates below a safety threshold (e.g., 0.3 meters per second or lower). While this speed restriction ensures safety, it reduces operational efficiency because the robot must travel long distances inside the trailer at a slow pace, making standard safety protocols impractical for high-speed trailer operations.

The embodiments described herein address the above-described challenge by implementing a controlled muting mechanism that temporarily disables safety fields while the robot operates in the confined space at a higher speed. A dock marker serves as a reference point and authorization signal, allowing the robot to identify its location and enter the confined space only when it is authorized and safe. The system may employ odometry-based tracking, LiDAR, cameras, and inertial measurement units (IMUs) to continuously monitor the robot's position relative to the trailer and pallets, ensuring precise movement even without active safety fields. Further enhancing safety, an emergency stop (E-stop) control may be implemented to provide immediate halting capabilities, while hazard zone monitoring ensures that safety measures are reactivated when necessary. Unlike conventional approaches that require the robot to reduce speed to 0.3 meters per second or lower, reducing efficiency, the embodiments described herein enable the robot to operate at higher speeds (e.g., 0.6 meters per second) while maintaining safety through marker-based authorization and alternative tracking methods, significantly improving productivity in warehouse and logistics environments.

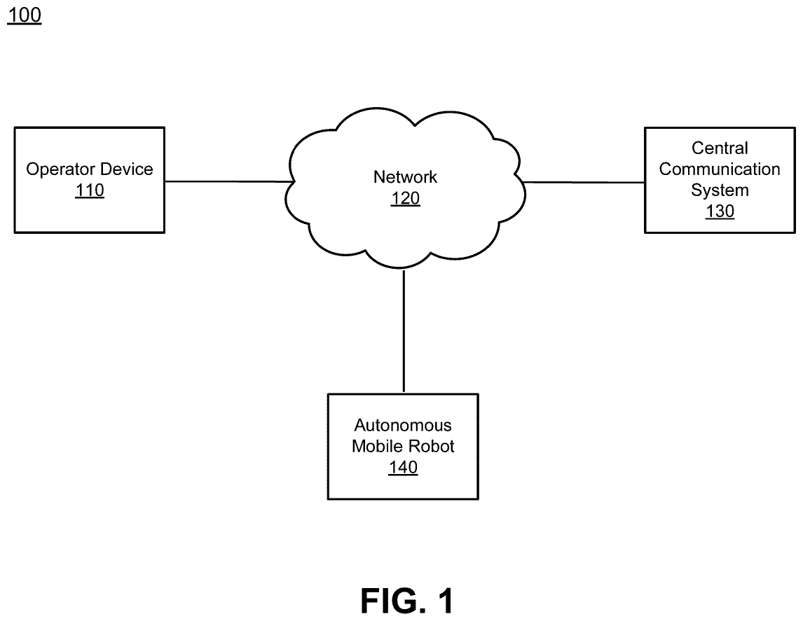

Additional details about the autonomous mobile robots are further described below with respect to FIGS. 1-7.

### System Environment

FIG. 1 illustrates an environment for operating an autonomous mobile robot using a central communication system, in accordance with some embodiments. Environment 100 includes operator device 110, network 120, central communication system 130, and autonomous mobile robot 140. Environment 100 may be generally described herein as a warehouse environment, however, environment 100 may be any kind of environment. Environment 100 need not be limited to a defined space (e.g., an interior of a warehouse), and may include any areas that are within the purview of instructions of an autonomous mobile robot (e.g., parking lots, loading docks, and so on that are outside of a warehouse space). While operator device 110 and central communication system 130 are depicted as being within environment 100, this is merely for convenience; these devices may be located outside of environment 100 (e.g., at a home, office, data center, cloud environment, etc.). Additional embodiments may include more, fewer, or different components from those illustrated in FIG. 1, and the functionality of each component may be divided between the components differently from the description below. Additionally, each component may perform their respective functionalities in response to a request from a human, or automatically without human intervention.

Operator device 110 may be any client device that interfaces one or more human operators with one or more autonomous mobile robots of environment 100 and/or central communication system 130. Exemplary client devices include smartphones, tablets, personal computers, kiosks, and so on. While only one operator device 110 is depicted, this is merely for convenience, and a human operator may use any number of operator devices to interface with autonomous mobile robots 140 or the central communication system 130. Operator device 110 may have a dedicated application installed thereon (e.g., downloaded from central communication system 130) for interfacing with the autonomous mobile robot 140 or the central communication system 130. Alternatively, or additionally, operator device 110 may access such an application by way of a browser. References to operator device 110 in the singular are done for convenience only, and equally apply to a plurality of operator devices.

Network 120 may be any network suitable for connecting operator device 110 with central communication system 130 and/or autonomous mobile robot 140. Exemplary networks may include a local area network, a wide area network, the Internet, an ad hoc network, and so on. In some embodiments, network 120 may be a closed network that is not connected to the Internet (e.g., to heighten security and prevent external parties from interacting with central communication system 130 and/or autonomous mobile robot 140). Such embodiments may be particularly advantageous where client device 110 is within the boundaries of environment 100.

Central communication system 130 acts as a central controller for a fleet of one or more robots including autonomous mobile robot 140. Central communication system 130 receives information from the fleet or the operator device 110 and uses that information to make decisions about activity to be performed by the fleet. Central communication system 130 may be installed on one device, or may be distributed across multiple devices. Central communication system 130 may be located within environment 100 or may be located outside of environment 100 (e.g., in a cloud implementation).

Autonomous mobile robot 140 may be any robot configured to act autonomously with respect to a command. For example, an autonomous mobile robot 140 may be commanded to move an object from a source area to a destination area, and may be configured to make decisions autonomously as to how to optimally perform this function (e.g., which side to lift the object from, which path to take, and so on). Autonomous mobile robot 140 may be any robot suitable for performing a commanded function. Exemplary autonomous mobile robots include vehicles, such as forklifts, mobile storage containers, etc. References to autonomous mobile robot 140 in the singular are made for convenience and are non-limiting; these references equally apply to scenarios including multiple autonomous mobile robots.

In some embodiments, the autonomous robot 140 may operate in different modes depending on its environment. For example, when operating in an open space, the robot 140 activates its safety field features, allowing its sensors to continuously monitor the surrounding area to detect obstacles, including objects and humans. Conversely, when the autonomous robot 140 operates in a confined space, such as a trailer, it disables the safety field features and activates odometry-based location tracking. The robot 140 may also adjust its speed based on the operational mode and environment. For instance, when operating in an open space with safety field features activated, the robot 140 may operate at a higher speed, such as greater than 0.6 m/s. However, when operating in a confined space with safety field features deactivated, the robot operates at a lower speed, e.g., between 0.3 and 0.6 m/s or below 0.3 s/m. The “higher speed” or “lower speed” described herein are relative to a safety threshold, which may be set based on safety standards. For example, some standards require the robot to reduce its speed to 0.3 m/s or below when safety fields are muted. In this context, 0.3 m/s is the safety threshold. A higher speed means a speed greater than 0.3 m/s, and a lower speed means a speed of no greater than 0.3 m/s.

The autonomous robot 140 may be tasked with loading and unloading pallets from a confined space, such as a trailer. In some embodiments, a removable marker is placed at the entrance of the trailer, indicating that it is safe for the robot to enter. The autonomous robot 140 includes sensors configured to scan the marker and determine whether it is authorized to enter the trailer. In some embodiments, the robot processes the scanned marker to determine entry authorization. Alternatively, or in addition, the autonomous robot 140 may transmit the scanned marker to the central communication system 130, which processes the marker data. In response to determining that the robot is authorized to enter the trailer, the central communication system 130 transmits a signal enabling entry, causing the robot to deactivate its safety field features and activate odometry-based location tracking.

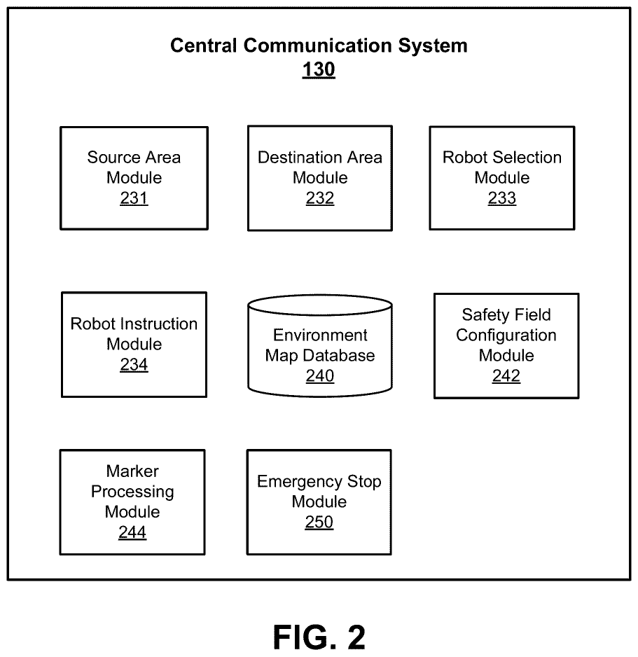

Additional details about the safety field features and safety operation in confined space are further described below with respect to FIGS. 2-8.

### Exemplary Central Communication System Configuration

FIG. 2 illustrates exemplary modules and data stores used by the central communication system 130, in accordance with some embodiments. The central communication system 130 may include a source area module 231, a destination area module 232, a robot selection module 233, a robot instruction module 234, an environment map database 240, safety field configuration module 242, a marker processing module 244, and an emergency stop (E-stop) module 250. The modules and databases depicted in FIG. 2 are merely exemplary; fewer or more modules and/or databases may be used by central communication system 130 to achieve the functionality disclosed herein. Additionally, the functionality of each component may be divided between the components differently from the description below. Additionally, each component may perform their respective functionalities in response to a request from a human, or automatically without human intervention.

The source area module 231 identifies a source area. The term source area, as used herein, may refer to either a single point, several points, or a region surrounded by a boundary (sometimes referred to herein as a source boundary) within which a robot is to manipulate objects (e.g., pick up objects for transfer to another area). In an embodiment, the source area module 231 receives input from operator device 110 that defines the point(s) and/or region that form the source area. In an embodiment, the source area module 231 may receive input from one or more robots (e.g., image and/or depth sensor information showing objects known to need to be moved (e.g., within a predefined load dock)), and may automatically determine a source area to include a region within a boundary that surrounds the detected objects. The source area may change dynamically as objects are manipulated (e.g., the source area module 232 may shrink the size of the source area by moving boundaries inward as objects are transported out of the source area, and/or may increase the size of the source area by moving boundaries outward as new objects are detected).

The destination area module 232 identifies a destination area. The term destination area, as used herein, may refer to either a single point, several points, or a region surrounded by a boundary (sometimes referred to herein as a destination boundary) within which a robot is to manipulate objects (e.g., drop an object off to rest). For example, where the objects are pallets in a warehouse setting, the destination area may include several pallet stands at different points in the facility, any of which may be used to drop off a pallet. The destination area module 232 may identify the destination area in any manner described above with respect to a source area, and may also identify the destination area using additional means.

The destination area module 232 may determine the destination area based on information about the source area and/or the objects to be transported. Objects in the source area may have certain associated rules that add constraints to the destination area. For example, there may be a requirement that the objects be placed in a space having a predefined property (e.g., a pallet must be placed on a pallet stand, and thus the destination area must have a pallet stand for each pallet to be moved). As another example, there may be a requirement that the objects be placed at least a threshold distance away from the destination area boundary, and thus, destination area module 232 may require a human draw the boundary at least at this distance and/or may populate the destination boundary automatically according to this rule (and thus, the boundary must be drawn at least that distance away). Yet further, destination area module 232 may require that the volume of the destination area is at least large enough to accommodate all of the objects to be transported that are initially within the source area.

Source area module 231 and destination area module 232 may, in addition to, or alternative to, using rules to determine their respective boundaries, may use machine learning models to determine their respective boundaries. The models may be trained to take information as input, such as some or all of the above-mentioned constraints, sensory data, map data, object detection data, and so on, and to output boundaries based thereon. The models may be trained using data on tasks assigned to robots in the past, such as data on how operators have defined or refined the tasks based on various parameters and constraints.

Robot selection module 233 selects one or more robots that are to transport objects from the source area to the destination area. In an embodiment, robot selection module 233 performs this selection based on one or more of a manipulation capability of the robots and a location of the robots within the facility. The term manipulation capability, as used herein, refers to a robot's ability to perform a task related to manipulation of an object. For example, if an object must be lifted, the robot must have the manipulation capability to lift objects, to lift an object having at least the weight of the given object to be lifted, and so on. Other manipulation capabilities may include an ability to push an object, an ability to drive an object (e.g., a mechanical arm may have an ability to lift an object, but may be unable to drive an object because it is affixed to, e.g., the ground), and so on. Further manipulation capabilities may include lifting and then transporting objects, hooking and then towing objects, tunneling and then transporting objects, using robots in combination with one another (e.g., an arm or other manipulates an object (e.g., lifts), places on another robot, and the robot then drives to the destination with the object). These examples are merely exemplary and non-exhaustive. Robot selection module 233 may determine required manipulation capabilities to manipulate the object(s) at issue, and may select one or more robots that satisfy those manipulation capabilities.

In terms of location, robot selection module 233 may select one or more robots based on their location to the source area and/or the destination area. For example, robot selection module 233 may determine one or more robots that are closest to the source area, and may select those robot(s) to manipulate the object(s) in the source area. Robot selection module 233 may select the robot(s) based on additional factors, such as a number of objects to be manipulated, manipulation capabilities of the robot (e.g., how many objects can the robot carry at once; sensors the robot is equipped with; etc.), motion capabilities of the robot, and so on. In an embodiment, robot selection module 233 may select robots based on a state of one or more robot's battery (e.g., a closer robot may be passed up for a further robot because the closer robot has insufficient battery to complete the task). In an embodiment, robot selection module 233 may select robots based on their internal health status (e.g., where a robot is reporting an internal temperature close to overheating, that robot may be passed up even if it otherwise optimal, to allow that robot to cool down). Other internal health status parameters may include battery or fuel levels, maintenance status, and so on. Yet further factors may include future orders, a scheduling strategy that incorporates a longer horizon window (e.g., a robot that is optimal to be used now may, if used now, result in inefficiencies (e.g., depleted battery level or sub-optimal location), given a future task for that robot), a scheduling strategy that incorporates external processes, a scheduling strategy that results from information exchanged between higher level systems (e.g., WMS, ERP, EMS, etc.), and so on.

The robot selection module 233 may select a robot using machine learning model trained to take various parameters as input, and to output one or more robots best suited to the task. The inputs may include available robots, their manipulation capabilities, their locations, their state of health, their availability, task parameters, scheduling parameters, map information, and/or any other mentioned attributes of robots and/or tasks. The outputs may include an identification of one or more robots to be used (or suitable to be used) to execute a task. The robot selection module 233 may automatically select one or more of the identified robots for executing a task, or may prompt a user of operator device 110 to select from the identified one or more robots.

The robot instruction module 234 transmits instructions to the selected one or more robots to manipulate the object(s) in the source area (e.g., to ultimately transport the object(s) to the destination area). In an embodiment, the robot instruction module 234 includes detailed step-by-step instructions on how to transport the objects. In another embodiment, the robot instruction module 234 transmits a general instruction to transmit one or more objects from the source area to the destination area, leaving the manner in which the objects will be manipulated and ultimately transmitted up to the robot to determine autonomously.

The robot instruction module 234 may transmit instructions to a robot to traverse from a start pose to an end pose. In some embodiments, the robot instruction module 234 simply transmits a start pose and end pose to the robot and the robot determines a path from the start pose to the end pose. Alternatively, the robot instruction module 234 may provide some information on a path the robot should take to travel from the start pose to the end pose. Robot pathfinding is discussed in more detail below.

Environment map database 240 stores information about the environment of the autonomous mobile robot 140. The environment of an autonomous mobile robot 140 is the area within which the autonomous mobile robot 140 operates. For example, the environment may be a facility or a parking lot within which the autonomous mobile robot 140 operates. In some embodiments, the environment map database 240 stores environment information in one or more maps representative of the environment. The maps may be two-dimensional, three dimensional, or a combination of both. Central communication system 130 may receive a map from operator device 110, or may generate one based on input received from one or more robots 140 (e.g., by stitching together images and/or depth information received from the robots as they traverse the facility, and optionally stitching in semantic, instance, and/or other sensor-derived information into corresponding portions of the map). In some embodiments, the map stored by the environment map database 240 indicates the locations of obstacles within the environment. The map may include information about each obstacle, such as whether the obstacle is an animate or inanimate object.

Environment map database 240 may be updated by central communication system 130 based on information received from the operator device 110 or from the robots 140. Information may include images, depth information, auxiliary information, semantic information, instance information, and any other information described herein. The environment information may include information about objects within the facility, obstacles within the facility, and auxiliary information describing activity in the facility. Auxiliary information may include traffic information (e.g., a rate at which humans and/or robots access a given path or area within the facility), information about the robots within the facility (e.g., manipulation capability, location, etc.), time-of-day information (e.g., traffic as it is expected during different segments of the day), and so on.

The central communication system 130 may continuously update environment information stored by the environment map database 240 as such information is received (e.g., to show a change in traffic patterns on a given path). The central communication system 130 may also update environment information responsive to input received from the operator device 110 (e.g., manually inputting an indication of a change in traffic pattern, an area where humans and/or robots are prohibited, an indication of a new obstacle, and so on).

The safety field configuration module 242 is configured to set features related to safety fields for autonomous robots 140. A safety field of an autonomous robot 140 is a detection zone surrounding the robot 140 that is being constantly monitored by sensors of the robot 140. In response to detecting an object within a safety field, the autonomous robot 140 can perform one or more remedial actions, such as reducing speed, stopping, detouring around the detected object, and/or generating alerts. In some embodiments, safety fields can be set as a customizable field, e.g., 0.5 m, 1 m, 3 m, extending from the robot towards the front, rear, and/or sides. In some embodiments, the shape of the safety field can also be customized, such as circular, rectangular, depending on the robot's shape and movement pattern. In some embodiments, the safety field configuration module 242 allows different field sizes and shapes for the front, rear, and sides.

In some embodiments, the safety fields may be set as dynamically scaling based on speed. For example, the safety field increases in size when the robot moves faster to allow more reaction time; and the safety field decreases when the robot moves slowly. In some embodiments, threshold speeds may be set for dynamically changing safety field behavior. For example, in response to detecting that the robot is moving at a speed greater than 0.6 m/s, the safety field expands; in response to detecting that the robot is moving at a speed below 0.3 m/s, the safety field can be muted.

The marker processing module 244 is configured to receive a scanned marker from an autonomous robot 140 and process the received marker to determine whether the robot is authorized to enter a specific area, such as a hazard zone, confined area, or trailer. The marker may be a QR code, fiducial marker, printed pattern, color-coded tag, or radio frequency (RF)-based marker, among others.

In some embodiments, the marker is encoded as a binary flag, indicating whether any autonomous robot 140 is permitted to enter. In other embodiments, the marker is encoded to indicate the nature of the specific area, such as a trailer, hazard zone, or the dimensions of a confined area or hazard zone. The marker processing module 244 processes the information encoded in the marker to determine whether the autonomous robot 140 should be allowed entry and whether the safety field features or other safety mechanisms should be activated or muted.

For example, in response to determining that the marker indicates the entrance of a trailer, the marker processing module 244 determines whether the autonomous robot 140 is authorized to enter. Based on this determination, the system instructs the robot to mute its safety field feature and activate its odometry-based location tracking before entering the trailer. The central communication system 130 then transmits a signal to the autonomous robot 140, causing its safety field feature to be deactivated and its odometry-based location tracking to be activated.

The E-stop module 250 is a safety control feature configured to immediately halt the operation of an autonomous robot 140 in response to an emergency stop command. In some embodiments, the E-stop module 250 may receive an emergency stop signal from the operator device 110, or a fixed emergency stop station located in a loading or unloading area, such as trailer entrance. In response to receiving an emergency stop signal, E-stop module 250 sends a wireless stop signal to the autonomous robot 140, triggering an immediate cessation of movement, regardless of its current operational mode. In some embodiments, the E-stop module 250 may also cause the robot 140 to generate visual and/or auditory alerts, such as flashing warning lights or audible alarms, to indicate when an emergency stop has been engaged. In some embodiments, the E-stop module 250 may incorporate redundant communication protocols, such as RF, Bluetooth low energy (BLE), or Wi-Fi, to enhance signal reliability and ensure fail-safe operation. In some embodiments, after an emergency stop, the robot 140 remains halted until an operator manually resets the system, preventing unintended reactivation.

### Exemplary Autonomous Mobile Robot Configuration

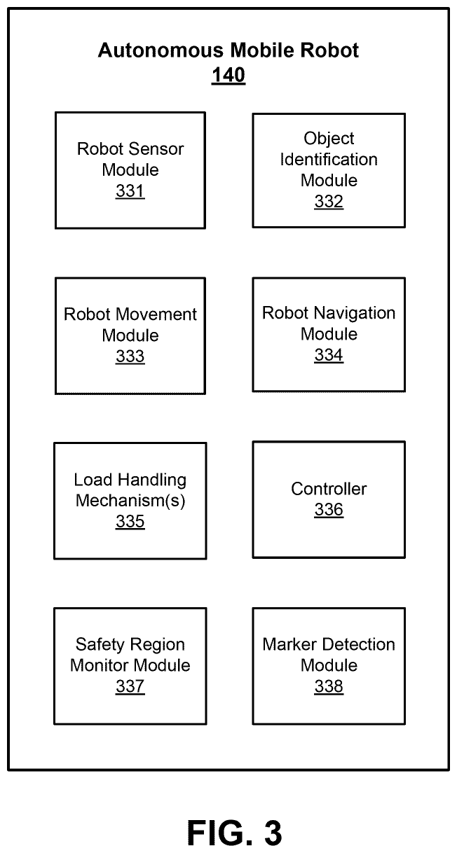

FIG. 3 illustrates exemplary modules and data stores used by the autonomous mobile robot, in accordance with some embodiments. As depicted in FIG. 3, autonomous mobile robot 140 includes a robot sensor module 331, an object identification module 332, a robot movement module 333, a robot navigation module 334, a load handling mechanism 335, a controller 336, a safety field monitor module 337, and marker detection module 338. The modules and databases depicted in FIG. 3 are merely exemplary; fewer or more modules and/or databases may be used to achieve the functionality described herein. Furthermore, any of the described functionality of the modules may instead be performed by the central communication system 130 or the operator device 110. Additionally, any of the functionality of these modules may be performed with or without human instruction.

The robot sensor module 331 includes a number of sensors that the robot uses to collect data about the robot's surroundings. For example, the robot sensor module 331 may include one or more cameras, one or more depth sensors, one or more scan sensors (e.g., RFID), a location sensor (e.g., showing location of the robot within the facility and/or GPS coordinates), and so on. Additionally, the robot sensor module 331 may include software elements for preprocessing sensor data for use by the robot. For example, the robot sensor module 331 may generate depth data information based on LIDAR sensor data. Data collected by the robot sensor module 331 may be used by the object identification module 332 to identify obstacles around the robot or may be used to determine a pose into which the robot must travel to reach an end pose.

The object identification module 332 ingests information received from the robot sensor module 331, and outputs information that identifies an object in proximity to the robot. The object identification module 332 may utilize information from a map of the facility (e.g., as retrieved from environment map database 240) in addition to information from the robot sensor module 331 in identifying the object. For example, the object identification module 332 may utilize location information, semantic information, instance information, and so on to identify the object.

Additionally, the object identification module 332 identifies obstacles around the robot for the robot to avoid. For example, the object identification module 332 determines whether an obstacle is an inanimate obstacle (e.g., a box, a plant, or a column) or an animate object (e.g., a person or an animal). The object identification module 332 may use information from the environment map database 240 to determine where obstacles are within the robot's environment. Similarly, the object identification module 332 may use information from the robot sensor module 331 to identify obstacles around the robot.

The robot movement module 333 transports the robot within its environment. For example, the robot movement module 333 may include a motor, wheels, tracks, and/or legs for moving. The robot movement module 333 may include components that the robot uses to move from one pose to another pose. For example, the robot may use components in the robot movement module 333 to change its x-, y-, or z-coordinates or to change its orientation. In some embodiments, the robot movement module 333 receives instructions from the robot navigation module 334 to follow a path determined by the robot navigation module 334 and performs the necessary actions to transport the robot along the determined path.

The robot navigation module 334 determines a path for the robot from a start pose to an end pose within the environment. A pose of the robot may refer to an orientation of the robot and/or a location of the robot (including x-, y-, and z-coordinates). The start pose may be the robot's current pose or some other pose within the environment. The end pose may be an ultimate pose within the environment to which the robot is traveling or may be an intermediate pose between the ultimate pose and the start pose. The path may include a series of instructions for the robot to perform to reach the goal pose. For example, the path may include instructions for the robot to travel from one x-, y-, or z-coordinate to another and/or to adjust the robot's orientation (e.g., by taking a turn or by rotating in place). In some embodiments, the robot navigation module 334 implements routing instructions received by the robot from the central communication system 130. For example, the central communication system 130 may transmit an end pose to the robot navigation module 334 or a general path for the robot to take to a goal pose, and the robot navigation module 334 may determine a path that avoids objects, obstacles, or people within the environment. The robot navigation module 334 may determine a path for the robot based on sensor data or based on environment data. In some embodiments, the robot navigation module 334 updates an already determined path based on new data received by the robot.

In some embodiments, the robot navigation module 334 receives an end location and the robot navigation module 334 determines an orientation of the robot necessary to perform a task at the end location. For example, the robot may receive an end location and an instruction to deliver an object at the end location, and the robot navigation module 334 may determine an orientation that the robot must take to properly deliver the object at the end location. The robot navigation module 334 may determine a necessary orientation at the end location based on information captured by the robot sensor module 331, information stored by the environment map database 240, or based on instructions received from an operator device. In some embodiments, the robot navigation module 334 uses the end location and the determined orientation at the end location to determine the end pose for the robot.

The load handling mechanism 335 is configured to lift and carry loads. In some embodiments, the load handling mechanism includes a fork and a lift assembly configured to raise and lower the fork. In some embodiments, the load handling mechanism 335 is also capable of horizontal movements (e.g., forward, retract, or shift horizontally) and angular movements (e.g., tilt forward or backward).

The controller 336 is configured to control the load handling mechanism 335 of the autonomous mobile robot 140. For example, when picking up a load, the controller 336 lowers the load handling mechanism 335 and adjusts a tilt of the load handling mechanism 335 to align the load handling mechanism 335 with a load. For example, when the load handling mechanism 335 includes a fork, the controller 336 can moves the fork horizontally cause the fork to reach deeper into a pallet before lifting. After picking up the pallet, the controller may also horizontally move the fork by adjusting a distance between the fork and a body of the robot 140 to stabilize the pallet. The controller 336 may tilt the fork forward or backward to adjust the pallet's angle. For stability during transport, the fork may tilt slightly backward to prevent the pallet from sliding off.

For unloading or storage, the controller 336 aligns the pallet at the appropriate height and angle for placement. During unloading, the fork may be tilted forward to ensure a smooth release of the load at the designated drop-off point.

When navigating uneven or angled surfaces, such as ramps or piecewise flat floors, the controller 336 adjusts the tilt to compensate for environmental angles, ensuring safe and steady handling. When navigating without a pallet, the controller 336 adjusts the movement based on the pose of the fork and the geometry of the environment to avoid contact with any slopes. When navigating with a pallet, the controller 336 additionally takes into account the pose and dimensions of the pallet to prevent both the fork and the pallet from striking a slope or encountering overhead obstructions, such as the ceiling of a trailer.

In some embodiments, the controller 336 is configured to control the operation of the fork based on various operational parameters, such as its height, tilt, and/or horizontal position. The controller 336 may also be configured with one or more reference constraints, which can include a minimum distance between the fork and the floor, a maximum allowable tilt angle of the fork, a maximum allowable tilt angle of the robot 140's body, and/or a maximum angle difference between two interconnected piecewise flat segments. The controller 336 continuously adjusts the fork's operational parameters to ensure these reference constraints are met. For example, when the autonomous mobile robot 140 transitions from a flat surface to a sloped area, the operational parameters that were sufficient on the flat surface may no longer meet the reference constraints during the transition. In such cases, the controller 336 adjusts the operational parameters to maintain compliance with the reference constraints. In certain situations, if the maximum or minimum operational parameters are still unable to meet the reference constraints, the controller 336 may stop the operation and issue an alert.

The safety field monitor module 337 is configured to cause the sensors to continuously track the position and movement of an autonomous robot 140 within predefined areas, distinguishing between safe and non-safe zones to ensure safe operation. Safe and non-safe zones refer to designated areas within the robot's operational environment that determine how safety measures, such as safety fields and speed restrictions, are applied to ensure safe operation while maintaining efficiency. These zones are typically defined based on safety standards.

Safe zones are areas where the robot's safety field is active, meaning sensors continuously monitor the surroundings to detect obstacles and human presence. The robot operates at a restricted or unrestricted speed, depending on environmental conditions. The risk of collision is minimized due to open space, predefined travel paths, or safety barriers. A safety field is a monitored region around the autonomous robot that dynamically adjusts based on movement, speed, and environmental conditions to prevent collisions. When the robot operates in a safe zone, the system continuously tracks both the robot's speed and location, dynamically adjusting the safety field depending on the speed. For example, when the robot moves at a higher speed, the safety field expands to allow earlier detection of obstacles. When operating in a non-safe zone, such as inside a trailer, the safety field may be muted while alternative safety mechanisms track the robot's movement to ensure controlled operation.

Non-safe zones are areas where the robot's safety field may need to be muted or adjusted, meaning the usual safety detection mechanisms are altered due to operational constraints. The robot is permitted to operate at a higher speed, but only under specific conditions. There is a higher risk of collisions, requiring alternative safety measures such as controlled access, position tracking, or emergency stop mechanisms.

The sensors may include (but are not limited to) LiDAR sensors, ultrasonic sensors, cameras, or RFID-based tracking systems to dynamically monitor the robot's movement relative to predefined safety fields. In some embodiments, the safety fields may be dynamically adjusted based on the robot 140's movement, speed, environmental condition, and operations.

The sensors are safety rated and their reliability is associated with a corresponding performance level. Performance level (PL) is a safety classification system defined in safety standards, that measures the reliability and effectiveness of a safety-related control system in machinery and robotics. PL determines how well a system can prevent hazardous failures and reduce risks in industrial automation and autonomous robotics. For example, performance level PL a applies to low-risk environments where safety failures do not pose significant hazards to humans or machinery. In this category, basic proximity sensors and standard cameras can be used for simple object detection without built-in fail-safe mechanism. As another example, performance level PL e is the highest level of safety assurance, required in very high risk applications where failures must be virtually eliminated. Sensors in this category may include (but are not limited to) safety integrity level (SIL)-rated safety scanners, multi-sensor fusion systems, and fully redundant vision-based safety systems.

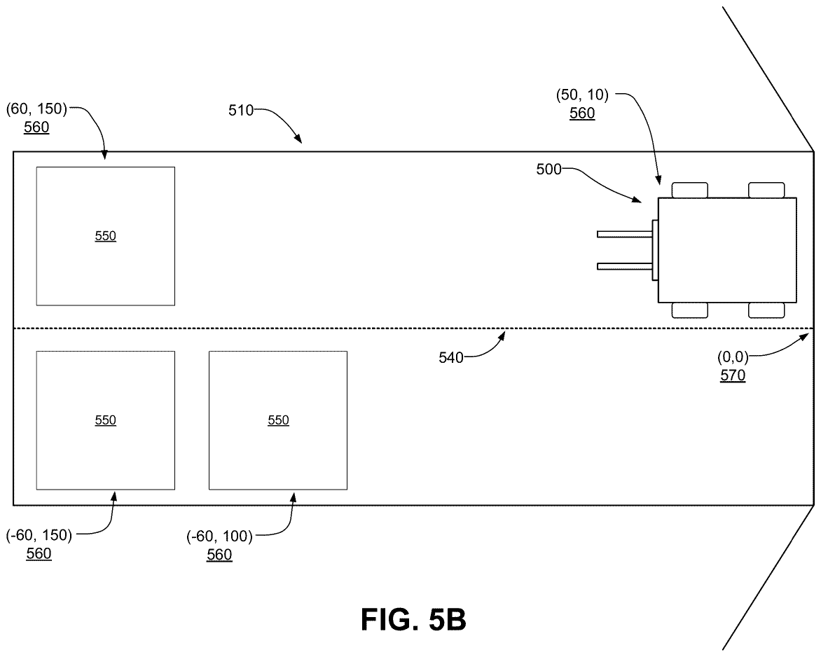

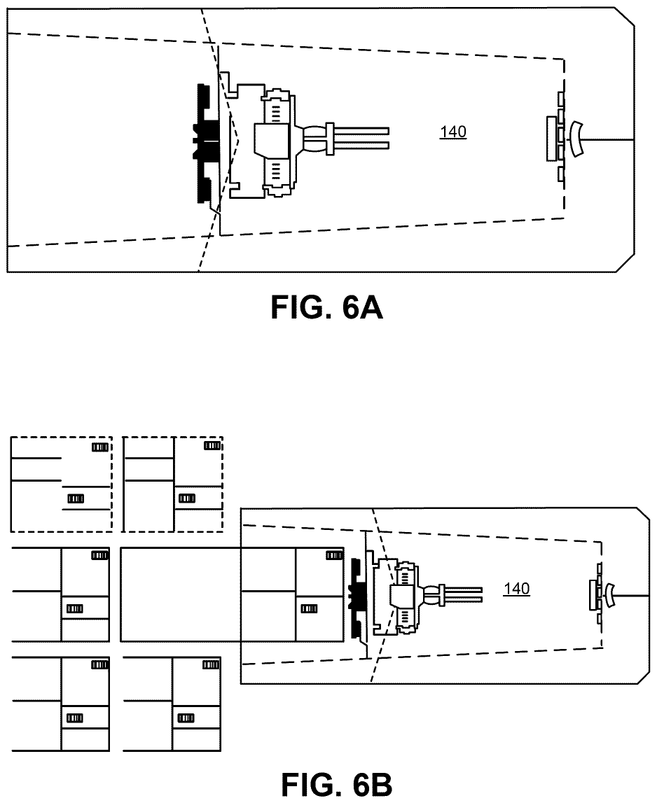

Additional details about safety field are further described below with respect to FIGS. 6A-6B.

The marker detection module 338 is configured to identify presence of a marker or other positional or authorization markers. The marker detection module 338 may use safety-rated LiDAR, camera-based vision systems, RFID readers, or ultrasonic sensors to detect a predefined marker positioned near an entrance of a confined area, such as a trailer dock or another designated location. These safety-rated components ensure reliable detection and compliance with PL and SIL requirements for industrial robotic safety. In particular, unlike traditional operation modes, these safety-rated components ensure that a robot only deactivates its safety field when a verified dock marker is detected, reducing the risk of unauthorized entry into hazardous areas. Because these components meet strict compliance standards, they provide the necessary redundancy, fault detection, and fail-safe mechanisms required for high-risk applications, such as autonomous loading and unloading operations inside a confined space. This compliance allows the system to safely override conventional speed restrictions (e.g., the 0.3 m/s speed limitation imposed by standard safety field operations) and operate at higher speeds (e.g., up to or greater than 1.2 m/s) within confined spaces while maintaining an equivalent or greater level of safety. By integrating SIL-rated and/or PL level certified sensors, autonomous robots can meet regulatory safety thresholds, allowing for increased efficiency without compromising workplace safety.

In some embodiments, in response to detecting the marker, the marker detection module 338 verifies its authenticity and positioning to ensure the robot is correctly aligned before transitioning into a trailer operation mode or other specialized navigation states. In some embodiments, the marker detection module 338 can distinguish between different marker types, such as QR codes, fiducial markers, LED indicators, Bluetooth Low Energy (BLE) beacons, and magnetic markers, allowing for flexible implementation across various environments. In some embodiments, the marker detection module 338 is also configured to parse the marker to extract additional information encoded in the marker, such as an identifier of the trailer, a dimension of a confined space, a specified speed or operation mode before entering the confined space, among others.

In response to detecting the marker, the autonomous robot 140 may transition to a different operation mode before entering the confined space, e.g., muting its safety field features, activating its odometry-based location tracking features, etc. In some embodiments, in response to detecting the absence of a marker or a marker that does not match expected parameters, the marker detection module 338 may trigger a warning, halt the robot's movement, refrain from entering the confined space, or require operator intervention before proceeding.

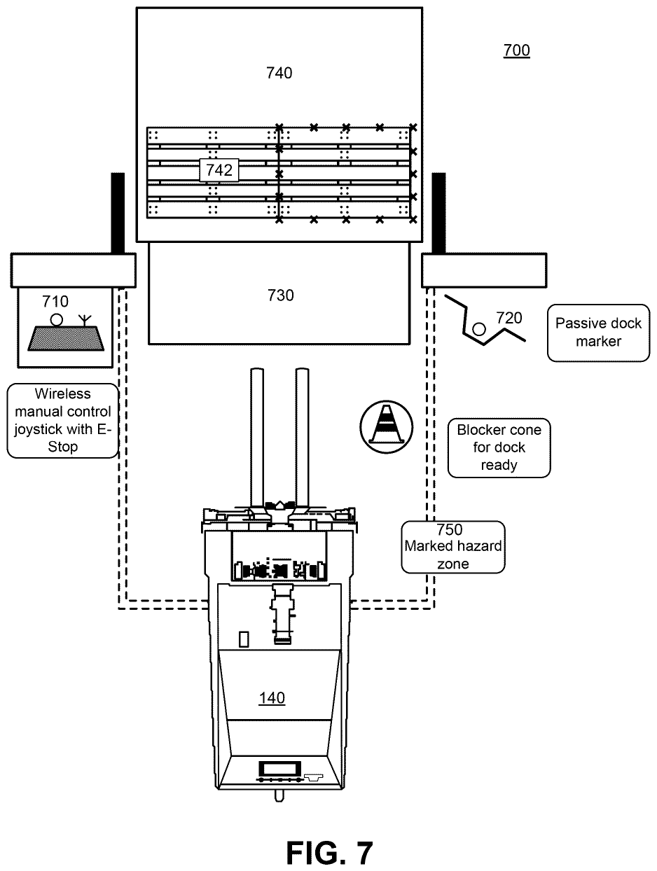

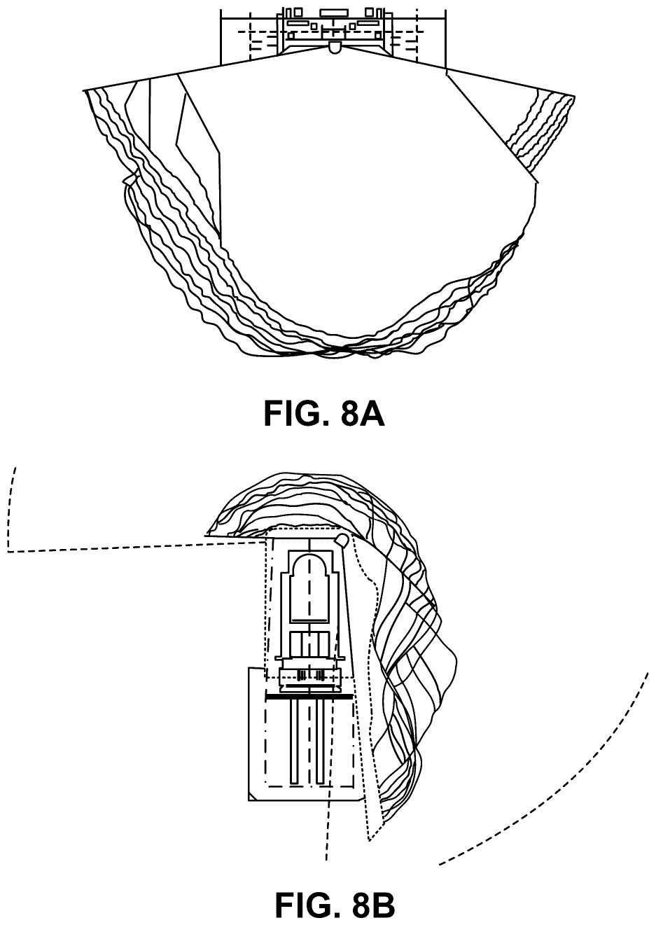

In some embodiments, the autonomous robot 140 processes the detected marker to determine whether it is authorized to enter the confined area. Alternatively, the marker detection module 338 transmits the detected marker to the central communication system 130, which then processes the marker to make a determination and transmits commands to the autonomous robot 140 based on that determination. These commands may include granting or denying entry to the confined area, muting the robot's safety field features, and activating other safety mechanisms as needed. Additional details about marker detection and higher speed, safe operation of autonomous robot 140 within a confined space are further described below with reference to FIGS. 7-8.

Although the descriptions provided herein are primarily about a fork-based load handling system, the same principles are applicable to other load handling mechanisms. Whether using clamps, grippers, or other types of lifting and transporting equipment, the methods of side-shifting, precise positioning, and sensor-based contact detection described can be implemented in a similar manner. These techniques ensure efficient handling of loads regardless of the specific mechanism employed by the autonomous mobile robot.

### Example Automated Trailer Loading and Unloading

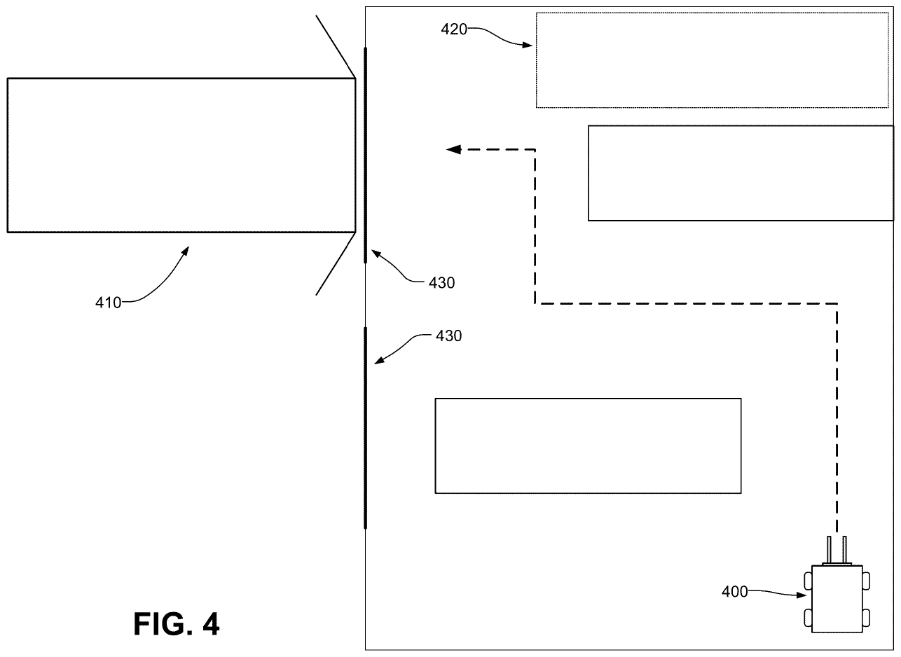

FIG. 4 illustrates an example autonomous mobile robot 400 navigating through a warehouse environment to a trailer 410, in accordance with some embodiments. The autonomous mobile robot 400 may have been instructed by a central communication system to load or unload the trailer 410. The central communication system also may have specified an area 420 to which autonomous mobile robot 400 may unload objects from the trailer 410 or from which the autonomous mobile robot 400 may obtain objects to load into the trailer 410. The central communication system may also specify which of a set docking points 430 the trailer 410 has docked to.

When the autonomous mobile robot reaches the docking point, the autonomous mobile robot may use sensor data to collect information about the trailer. The sensor data is data collected by one or more sensors on the autonomous mobile robot. For example, the sensor data may include LIDAR data captured by a LIDAR sensor and/or image data captured by a camera. In some embodiments, the sensor data includes data that describes the locations of objects and obstacles around the autonomous mobile robot in a two-dimensional space and/or a three-dimensional space. The autonomous mobile robot may determine characteristics of the trailer based on the sensor data. For example, the autonomous mobile robot may determine the width, height, depth, centerline, off-center parking, yaw, roll, and/or pitch of the trailer.

Additionally, the autonomous mobile robot may determine its location relative to the trailer based on the sensor data. For example, the autonomous mobile robot may identify some point or part of the trailer and determine its location with respect to that point or part. The autonomous mobile robot may use the sensor data determine its location and orientation relative the trailer. Furthermore, the autonomous mobile robot may identify objects in the trailer and may determine poses of the objects. For example, the autonomous mobile robot may identify pallets, including the types of the pallets, and may determine their location and orientation within the trailer. In some embodiments, the autonomous mobile robot continually determines its location, and the locations of objects and obstacles, based on continually received sensor data. The autonomous mobile robot may continually receive sensor data on a regular or irregular basis.

In some embodiments, the autonomous mobile robot uses a machine-learning model (e.g., a neural network) to determine characteristics of the trailer based on sensor data. For example, the machine-learning model may be a computer-vision model that has been trained to determine characteristics of a trailer based on image data captured by a camera on the autonomous mobile robot. Similarly, the machine-learning model may be trained to determine the location and orientation of objects within the trailer based on sensor data.

The autonomous mobile robot may enter the trailer and use sensor data of the trailer to determine the autonomous mobile robot's location with respect to the trailer. Additionally, the autonomous mobile robot may determine the location of the objects in the trailer, and any obstacles in the trailer, with respect to the trailer based on the sensor data. The autonomous mobile robot identifies an object to unload from the trailer and manipulates the object using a forklift component. In some embodiments, while the autonomous mobile robot navigates within the trailer, the autonomous mobile robot travels slightly offset from a centerline of the trailer so that the autonomous mobile robot is more likely to be in a correct position to manipulate an object within the trailer. In these embodiments, by remaining slightly offset from the centerline of the trailer, the autonomous mobile robot will likely be able to position its forks to lift an object by simply side-shifting its forks.

In some embodiments, the autonomous mobile robot uses an enhanced navigation algorithm while navigating within the trailer. An enhanced navigation algorithm may enable the autonomous mobile robot to determine its location more accurately within the trailer and to determine more accurately the locations of objects and obstacles within the trailer. The enhanced navigation algorithm may be more precise than a navigation algorithm used by the autonomous mobile robot while the autonomous mobile robot navigates within the warehouse environment. In some embodiments, the enhanced navigation algorithm uses a map within the trailer that has a finer resolution than the environment map. Similarly, the enhanced navigation algorithm may use denser motion primitives to navigate within the trailer than a navigation algorithm used by the autonomous mobile robot when navigating within the warehouse environment. In some embodiments, the enhanced navigation algorithm uses a modified version of A* search to navigate within the trailer. Furthermore, the enhanced navigation algorithm may use sensor data with a narrower field of view than the sensor data used a navigation algorithm used while the autonomous mobile robot navigates within the warehouse environment.

The autonomous mobile robot may detect when it has entered the trailer and may start using an enhanced navigation algorithm upon determining that it has entered the trailer. The autonomous mobile robot may use the enhanced navigation algorithm to position itself to manipulate objects within the trailer and to transport an object out of the trailer. Furthermore, the autonomous mobile robot may detect when it has exited the trailer and stop using an enhanced navigation algorithm upon determining that it is no longer in the trailer.

In some embodiments, the autonomous mobile robot uses a first navigation algorithm to determine a route from a first pose in the warehouse environment to a second pose near an entrance to the trailer. The autonomous mobile robot may then use a second navigation algorithm to determine a route from the second pose to a third pose within the trailer from which the autonomous mobile robot can manipulate an object. The first navigation algorithm may be a navigation algorithm that the autonomous mobile robot uses to navigate within the warehouse environment and the second navigation algorithm may be an enhanced navigation algorithm that the autonomous mobile robot uses to determine its location within the trailer. Thus, the second navigation algorithm may be a navigation algorithm with a higher level of precision than the first navigation algorithm. For example, the second navigation algorithm may use a map with a finer resolution or may use more precise or dense motion primitives to determine a route.

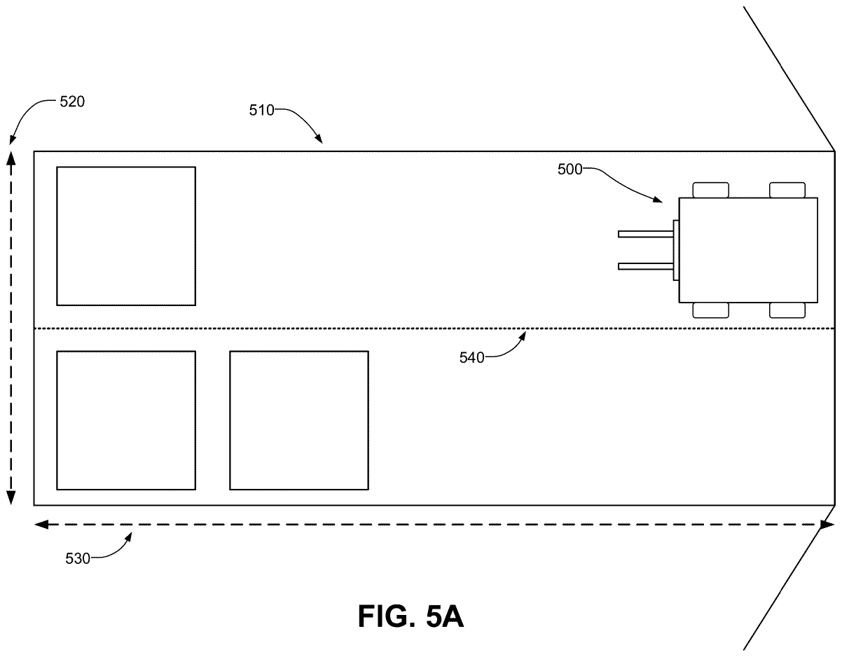

FIGS. 5A and 5B illustrate an example autonomous mobile robot 500 navigating within a trailer 510 and determining characteristics of the trailer 510, in accordance with some embodiments. FIG. 5A illustrates example characteristics that the autonomous mobile robot 500 may determine based on sensor data. For example, the autonomous mobile robot 500 may determine a width 520 and a depth 530 of the trailer 510. Additionally, the autonomous mobile robot 20 may determine the location of a centerline 540 of the trailer 510.

FIG. 5B illustrates example locations 560 of the autonomous mobile robot 500 and objects 550 within the trailer 510, as determined by the autonomous mobile robot 500. The autonomous mobile robot 500 determines the locations 560 of itself and objects 550 relative to the trailer 510. In the embodiment illustrated in FIG. 5B, the locations 560 of the autonomous mobile robot 500 and the objects 550 are determined relative to an origin location 570, however alternative embodiments may determine locations 560 within the trailer 510 relative to any part of the trailer 510.

### Different Trailer Operations Safety Modes

FIGS. 6A and 6B illustrate examples of safety field features for an autonomous robot 140, in accordance with one or more embodiments. As shown in FIG. 6A, the safety field surrounds the front, rear, and sides of the autonomous robot 140. The safety field is continuously monitored by onboard sensors of the autonomous robot 140, such as LiDAR, ultrasonic sensors, stereo cameras, or radar, which provide real-time data about the robot's surroundings. These sensors allow the robot to identify and respond to potential hazards, including stationary objects, moving objects, and human operators.

As the robot 140 moves from point A to point B, its sensors actively scan the entire safety field to detect whether there is an obstacle. In response to detecting an obstacle within the safety field, the robot can take corrective actions, such as rerouting, slowing down, or stopping entirely, depending on the proximity and movement of the obstacle. For example, if a worker unexpectedly steps into the safety field or an object falls within the robot's path, the robot's sensors detect the worker, which may trigger an emergency stop, activate audible and/or visual alerts, or communicate with a central control system for further action. Additionally, in some embodiments, the robot 140 may be able to differentiate between temporary obstacles (e.g., a moving person) and permanent obstructions (e.g., a cone), enabling more sophisticated decision-making.

In some embodiments, a width or a size of a safety field may be a predetermined distance, e.g., 1 m, 0.5 m, 0.25 m. Alternatively, or in addition, a width of a safety field may be dynamically adjusted based on real-time conditions. For example, when the robot is traveling at high speed, the safety fields may expand to allow for earlier hazard detection and increased stopping distance.

As another example, the safety field may be dynamically adjusted based on the robot's operation and environment conditions, such as whether the robot is carrying a pallet. Referring to FIG. 6B, a robot is carrying a pallet, and its safety field extends beyond the fork and pallet for a predetermined distance. This expanded safety field ensures safe pallet transport, preventing collision and maintaining a buffered operational space around the pallet and carried load.

Notably, safety fields provide robots with a buffered operational space, ensuring safe movement with adequate clearance. However, when a robot enters a confined space, such as a trailer, the available margin is significantly reduced, making it impractical to maintain the same safety field size. In such environments, the robot may mute its safety field features. However, muting the safety features can be dangerous. For example, a robot can run over an obstacle or a person who is manipulating a pallet in a trailer while robot is operating. Thus, existing safety standards allow muting only when the robot operates at a reduced speed, such as no greater than 0.3 meters per second (m/s). However, this speed reduction is impractical for trailer operations due to the long distances the robot must travel inside the trailer, significantly decreasing operational efficiency. To move faster than 0.3 m/s, the robot must operate with proper safety measures, and muting of safety fields must be strictly controlled to minimize risks.

One approach to operate a robot at speeds greater than 0.3 m/s is to implement a compliant restricted zone. However, several issues arise in implementing such restricted zones. First, the dock infrastructure needs to be upgraded, including installation of safety programmable logic controller (PLC), light curtains, muting sensors, fences, wiring, power reliability, and operator panels. Further, clearances and distances between docks and entrance area need to be increased to accommodate safety equipment. Due to high costs, spatial limitations, and technical challenges, this approach is not practical for most facilities.

Embodiments described herein include an alternative approach that enable safety measures to allow the robot to operate at higher speeds (>0.3 m/s). FIG. 7 illustrates an example embodiment of a trailer operations safety system 700, in accordance with one or more embodiments. The system 700 includes an emergency stop (E-stop) control 710 and a dock marker 720 near a dock 730 of a trailer 740.

When a robot 140 approaches the dock 730 of trailer 740 with its safety fields fully active, the robot can detect whether a dock marker 720 is present. In response to detecting the dock marker 720, the robot 140 transitions into a trailer operation mode. In trailer operation mode, the safety fields are muted, allowing pallet manipulation and movement within the confined space while the robot operates at a speed greater than 0.3 m/s. Note, the dock marker 720 is present only when it is safe for the autonomous robot 140 to enter the trailer. If operators are inside the trailer, the dock marker is either disabled or blocked.

In some embodiments, the dock marker 720 may be a fixed object (e.g., a metal plate) with a unique shape or pattern. The robot's safety-rated LiDAR or camera-based safety scanners can detect the marker's specific pattern on the same performance level corresponding to the safety field. Alternatively, or in addition, the dock marker 720 may be a QR code or fiducial marker, an RFID marker, an LED marker, an ultrasonic marker, a magnetic marker, a Bluetooth low energy (BLE) marker, among others. When the dock marker 720 is a passive marker, it can be disabled by simply blocking it with a blocker, such as a cone or a cover. When the dock marker 720 is an active marker, it can be turned on or off via a switch attached to the marker 720, a remote control, or a mobile application on an operator device 110.

Different safety field configurations (size, sensitivity, activation mode) require different performance levels depending on the environment. As described above, performance levels (PL) may be defined in safety standards, which sets requirements for the safety of machinery, including autonomous robots. Performance level determines the reliability and effectiveness of safety-related control systems in reducing risk levels.

A standard safety field is a fully active protective zone around the autonomous robot with continuous obstacle detection and collision. Since this configuration provides real-time safety monitoring, it typically requires a moderate reliability in detecting and responding to obstacles.

A dynamic safety field adjusts its size based on the robot's speed, environmental constraints, and task requirements. Due to its complex real-time adjustments and reliance on advanced sensor fusion, this safety field configuration typically requires a higher performance level to maintain consistent safety across various operating conditions.

A muted safety field configuration is used to confined spaces where traditional safety fields cannot function effectively, such as when an autonomous forklift operates inside a trailer or a narrow aisle. Given the critical nature of maintaining safety without direct safety fields monitoring, a highest performance level may be required, ensuring maximum reliability and fault tolerance in high-risk scenarios. Sensors operating in such a muted safety field configuration may be highly rated components, such as SIL-rated components.

When the safety fields are muted in the trailer operation mode, the robot loses its normal capability of detecting surrounding obstacles and preventing collisions. To compensate for muted safety field, alternative safety mechanisms are implemented to ensure controlled navigation inside the trailer 740. In some embodiments, to compensate for the muted safety fields, the robot 140 continuously tracks its position relative to the trailer 740 using odometry, LiDAR, cameras, inertial measurement units (IMUs), GPS (global positioning system), and/or other localization technologies. In some embodiments, the robot 140 is also aware of the locations of pallets inside the trailer, allowing it to navigate efficiently and manipulate loads without collisions.

Odometry-based tracking is a navigation technique used to estimate the robot 140's position, orientation, and movement based on sensor data from wheel encoders, IMUs and other onboard sensors. This method allows the robot to track its motion in real time, even when external localization references (such as GPS or visual markers) are unavailable. By maintaining an awareness of its location relative to the trailer 740 and/or pallets 742, the robot 140 can operate safely and efficiently, even without its usual safety fields.

For example, when exiting the trailer, the robot 140 may use odometry-based tracking to determine whether it is outside of the trailer. In response to determining that the robot moves out of the trailer, the safety fields are automatically reactivated based on the robot's position tracked by its encoders. The safety fields are reactivated when the robot reaches the same positional reference as used for marker detection upon entering the trailer. Unlike entry detection, dock marker detection is not required for exiting, as the system relies on position-based tracking to determine when to reactivate the safety field.

In some embodiments, when the robot completes its task (e.g., placing or retrieving one or more pallets), it moves back toward the dock entrance or a designated location (e.g., a staging area, a charging dock) where the robot 140 waits for its next command.

In addition to the dock marker 720, the E-stop control 710 is another safety feature. The E-stop control 710 may be a remote wireless E-stop control that allows operators to immediately halt the robot if necessary. In some embodiments, the E-stop control 710 may include a button or a joystick installed in a location near the dock 730. Alternatively, or in addition, the E-stop control 710 may include a handheld controller or a mobile application installed on an operator device 110 carried by an operator.

The E-stop control 710 is a safety-rated component, ensuring reliable emergency stopping at the same performance level as safety field detection. In some embodiments, in response to pressing the button or pulling the joystick, the E-stop control 710 transmits a wireless signal to the robot 140, causing it to stop immediately. Alternatively, the E-stop control 710 may transmit a signal to the central communication system 130, which in turn transmits a wireless signal to the robot 140 to ensure an immediate stop.

Various technologies may be implemented to ensure reliable and instantaneous communication between the E-stop control 710 and the robot 140. In some embodiments, the E-stop control 710 may include a transmitter configured to transmit a wireless signal indicating a stop command, and the robot 140 may include a receiver configured to receive the wireless signal. In response to receiving the wireless signal, the robot 140 halts all movement immediately to prevent potential collisions, hazards, or safety violations. The stop mechanisms may be implemented using fail-safe electronic and control systems that override the robot's normal operations. The transmitter and receiver may be radio frequency (RF)-based, infrared (IR)-based, ultrasonic, WiFi-based, BLE-based, cellular-based, such as 3G/4G/5G/6G-based.

In some embodiments, an area around the dock 730 is marked as a hazard zone 750. The hazard zone may be marked with visual markers, or geofence. In some embodiments, the robot 140 uses its onboard sensors to detect visual markers to determine whether it enters a hazard zone. Alternatively, or in addition, the robot 140 monitors its geolocation to determine whether it enters a hazard zone 750. In response to determining that the robot 140 enters a hazard zone 750, the robot 140 actively monitors whether there is a dock marker 720. In response to detecting the dock marker 720, the robot 140 enters the trailer operation mode, which allows the robot 140 to mute its safety field features and operate inside the trailer.

In some embodiments, when the autonomous robot 140 is inside the confined space, it comes to a stop before performing an operation, such as loading or unloading a pallet. During such operations, at least a portion of the safety field may be dynamically reactivated to ensure clearance in areas associated with the operation, such as loading or unloading areas.

FIG. 8A illustrates an example safety field of an autonomous robot 140 that may be dynamically activated during a loading or unloading operation, in accordance with one or more embodiments. As illustrated, a front safety field or a drop-off area may be activated to prevent collisions and verify that there are no obstructions before the pallet is placed or removed.

FIG. 8B illustrates another example safety field of an autonomous robot 140 that may be dynamically activated during a side shift operation. During the loading or unloading process, the robot 140 may need to perform a side shift operation, where it shifts the fork assembly laterally to ensure proper alignment with the pockets of the pallet. In such cases, at least some portions of the safety field, particularly in the side area corresponding to the direction of the shift, are dynamically reactivated to detect nearby obstacles and ensure safe fork positioning. This dynamic activation of safety fields enhances operational safety by maintaining necessary obstacle detection without unnecessarily restricting the robot's ability to maneuver and complete its tasks efficiently.

As shown in FIGS. 8A and 8B, the safety fields dynamically activated inside the trailer may cover a smaller area compared to the regular safety fields used during normal operation. These modified safety fields are specifically adjusted to accommodate the confined space of the trailer while ensuring that the robot 140 can operate efficiently without unnecessary stops. Depending on the operation, the active safety field may be limited to a localized region in front of, beside, or around the robot to provide essential obstacle detection while allowing safe maneuvering within the restricted environment.

### Example Method for Safely Operating Autonomous Robots in Confined Spaces

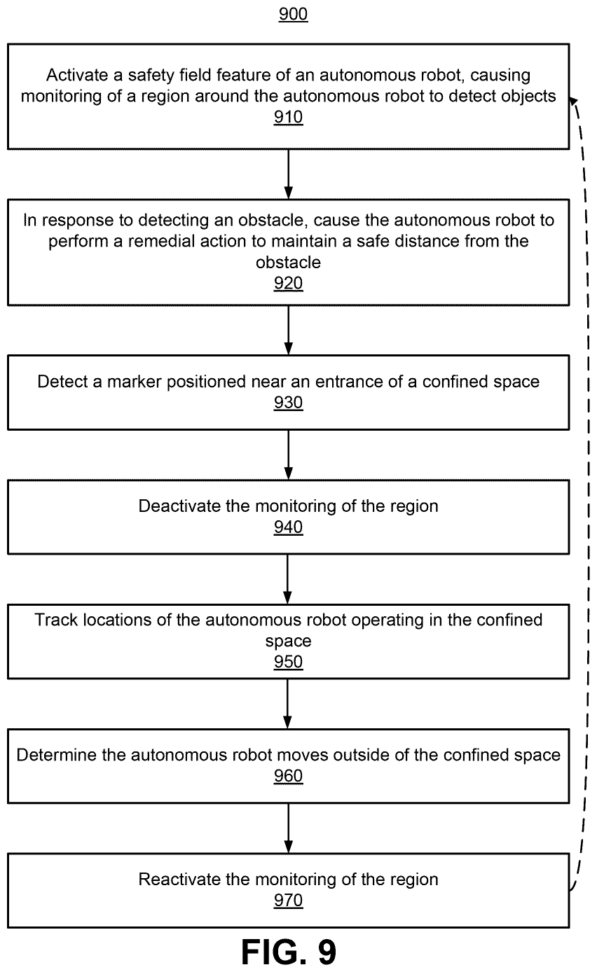

FIG. 9 is a flowchart of an example method 900 for efficiently operating an autonomous robot in a confined space, in accordance with one or more embodiments. The method may be performed by a system, including the autonomous robot 140, the central communication system 130, and/or the operator device 110. In some embodiments, there may be more or fewer steps performed as shown in FIG. 9.

The system activates 910 a safety field of an autonomous robot. The safety field is a region around the autonomous robot to detect objects within the region. In response to detecting an object, the system causes 920 the autonomous robot to perform a remedial action to maintain a threshold distance from the object. The remedial action may include (but is not limited to) slowing down, stopping, detouring around the object, etc. Various objects may be in the path of the robot's operation, such as obstacles and humans. The safety field serves as a buffer. Referring to FIGS. 6A and 6B, the safety field may include front, rear and sides of the robot, extending to a predetermined distance from the robot's body. In some embodiments, the safety field can be dynamically adjusted based on the robot's speed and operational state. For example, when the robot operates at higher speeds, the safety field may extend to a larger area to provide additional margin for stopping and collision prevention. Additionally, when the robot is carrying a pallet, the safety field may extend not only in the front area but also on the sides if the pallet or its load exceeds the robot's dimensions. This ensures an adequate buffer zone around the load for safe navigation and collision prevention.

The safety field may be monitored by safety-rated sensors, such as LiDAR (configured to create a real-time 3D map of the surroundings), ultrasonic sensors (configured to detect objects based on sound wave reflections), stereo cameras or depth sensors (configured to provide visual recognition of objects and depth estimation), and/or infrared sensors (configured to detect objects based on heat signatures). These safety-rated components ensure reliable obstacle detection and compliance with operational safety standards.

In open environments, these safety fields ensure that the robot maintains a safe distance from obstacles, objects, and human operators. However, inside a trailer or another confined space, this margin is severely limited, making it impractical for the robot to operate with the safety fields active. To solve this problem, the system includes a removable or activatable marker positioned near an entrance of a confined space, indicating that the autonomous robot is to enter the confined space.

The robot detects 930 whether there is a marker positioned near an entrance. This step may be performed by a marker detection module 338 of FIG. 3. The marker may include one or more of a QR code, an RFID tag, a fiducial marker, a Bluetooth Low Energy (BLE) beacon, an LED marker, an ultrasonic marker, or a magnetic marker.

In response to detecting the marker, the system deactivates 940 the safety field to allow the autonomous robot to discard objects, including walls of the confined space, that would otherwise be detected within the safety field, thereby enabling the autonomous robot to operate close to the walls of the confined space within the threshold distance. Even though the monitoring of the surrounding region is stopped, additional safety measures are used to ensure safety operation. In some embodiments, in response to deactivating the monitoring of the region surrounding the autonomous robot, the robot is caused to generate an alert, such as flashing lights or an audible warning.

Further, the system may continue to track locations of the autonomous robot within the confined space. In some embodiments, the tracking of the locations is based on odometry sensors, such as wheel encoders and IMU, and GPS. The wheel encoders measure wheel rotations to determine how far the robot has moved, and the system can calculate distance traveled and turning angles based on differential movement of wheels. The IMU uses accelerometers and gyroscopes to track the robot's speed, orientation, and movement direction, which can help correct errors from wheel slippage or uneven surfaces. The odometry system may integrate multiple sensors (including LiDAR, depth camera, or RFID) to improve position accuracy.

The system determines 950 whether the autonomous robot moves outside the confined space based on the tracked location. In response to determining that the autonomous robot moves outside the confined space, the system reactivates 960 the monitoring of the region surrounding the autonomous robot, causing the robot to monitor 910 the region around itself to detect objects within the region again.

This process can repeat. Each time, the robot detects 830 a marker positioned near an entrance of a confined space, the safety field is disabled to allow the robot operate in the confined space. An operator may disable (e.g., physically blocking the marker with object) the marker at any time. In response to disabling the marker, the robot will no longer detect the marker. In some embodiments, in response to detecting absence of the marker, the robot may stop at the entrance to the confined space, and/or generate an alert, including flashing lights or an audible warning.

In some embodiments, when the robot is inside the confined space, it comes to a stop before performing an operation, such as loading or unloading a pallet. During such operations, at least a portion of the safety field may be dynamically reactivated to ensure clearance in areas associated with the operation, such as loading or unloading areas. In some embodiments, the system dynamically reactivating at least a front portion of the safety field of the robot during loading or unloading of a pallet by the robot inside the trailer. In some embodiments, the system also dynamically reactivating at least a side portion of the safety field of the robot during side shift operation, in which the autonomous robot laterally shifts a fork to align with pockets of a pallet.

In some embodiments, the system also includes an emergency stop, when activated, the emergency stop is configured to transmit a wireless signal to the robot, indicating emergency stop. In response to receiving the wireless signal, the robot halts its operation immediately, providing extra safety measures.

Traditionally, when the safety field is deactivated (also referred to as muted), the robot can only operate at a speed no greater than 0.3 m/s. The embodiments described herein provide additional safety features (e.g., tracking its location relative to a trailer, marker detection, and E-stop system), such that the robot is able to safely operate at a speed much higher than 0.3 m/s. In some embodiments, the robot is configured to operate at up to 1.2 m/s within the confined space, near doubling the efficiency.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method for safely operating an autonomous robot in a confined space, comprising:
activating a safety field of the autonomous robot, the safety field being a region around the autonomous robot, causing monitoring of the region to detect objects within the region;
in response to detecting an object within the safety field while the autonomous robot traverses toward a target zone comprising a confined space, causing the autonomous robot to perform a remedial action including reducing speed below a threshold level;
detecting a marker positioned at an entrance to the confined space, the marker indicating that the autonomous robot is authorized to enter the confined space;
in response to detecting the marker,
deactivating the safety field to cause the autonomous robot to disregard objects within the confined space that would otherwise be detected within the safety field, thereby enabling the autonomous robot to operate close to the objects within the confined space without reducing speed below the threshold level;
determining that the autonomous robot has traversed outside of the confined space; and
in response to determining that the autonomous robot has traversed outside of the confined space, reactivating the safety field of the autonomous robot.

2. The method of claim 1, wherein the autonomous robot includes one or more sensors configured to monitor the region around the autonomous robot, the one or more sensors comprising one or more of: a LiDAR sensor, an ultrasonic sensor, or a stereo camera.

3. The method of claim 1, wherein the marker includes one or more of: a QR code, an RFID tag, a fiducial marker, a Bluetooth Low Energy (BLE) beacon, an LED marker, an ultrasonic marker, or a magnetic marker.

4. The method of claim 1, wherein the robot is configured to operate at a speed greater than 0.3 meters per second inside the confined space.

5. The method of claim 1, wherein determining that the autonomous robot has traversed outside of the confined space includes tracking locations of the autonomous robot relative to the confined space by one or more sensors.

6. The method of claim 1, the method further comprising:
in response to receiving a wireless signal indicating emergency stop from a controller, halting the autonomous robot.

7. The method of claim 1, the method further comprising:
in response to detecting absence of the marker, causing the robot to stop at the entrance to the confined space.

8. The method of claim 7, the method further comprising:
in response to detecting absence of the marker, causing the autonomous robot to generate an alert, including flashing lights or an audible warning.

9. The method of claim 1, wherein the confined space is a trailer, and the autonomous robot is configured to load or unload pallets from the trailer.

10. The method of claim 1, further comprising dynamically reactivating at least a front portion of the safety field of the autonomous robot during loading or unloading of a pallet by the autonomous robot inside the confined space.

11. The method of claim 1, further comprising dynamically reactivating at least a side portion of the safety field of the autonomous robot during a side shift operation inside the confined space, in which the autonomous robot laterally shifts a fork to align with pockets of a pallet.

12. The method of claim 1, wherein the remedial action incudes one or more of following: reducing speed, detouring around a detected object, stopping, or generating an alert.

13. An autonomous robot comprising:
one or more sensors;
one or more processors; and
a non-transitory computer-readable medium storing instructions that, when executed by the processor, cause the processor to perform steps comprising:
activating a safety field of the autonomous robot, the safety field being a region around the autonomous robot, causing monitoring of the region to detect objects within the region;
in response to detecting an object within the safety field while the autonomous robot traverses toward a target zone comprising a confined space, causing the autonomous robot to perform a remedial action including reducing speed below a threshold level;
detecting a marker positioned at an entrance to the confined space, the marker indicating that the autonomous robot is authorized to enter the confined space;
in response to detecting the marker,
deactivating the safety field to cause the autonomous robot to disregard objects within the confined space that would otherwise be detected within the safety field, thereby enabling the autonomous robot to operate close to the objects within the confined space without reducing speed below the threshold level;
determining that the autonomous robot has traversed outside of the confined space; and
in response to determining that the autonomous robot has traversed outside of the confined space, reactivating the safety field of the autonomous robot.

14. The autonomous robot of claim 13, wherein the autonomous robot includes one or more sensors configured to monitor the region around the autonomous robot, the one or more sensors comprising one or more of: a LiDAR sensor, an ultrasonic sensor, or a stereo camera.

15. The autonomous robot of claim 13, wherein the marker includes one or more of: a QR code, an RFID tag, a fiducial marker, a Bluetooth Low Energy (BLE) beacon, an LED marker, an ultrasonic marker, or a magnetic marker.

16. The autonomous robot of claim 13, the steps further comprising:
in response to detecting absence of the marker, causing the robot to stop at the entrance to the confined space.

17. The autonomous robot of claim 13, the steps further comprising:
in response to detecting absence of the marker, causing the robot to stop at the entrance to the confined space.

18. The autonomous robot of claim 13 wherein the confined space is a trailer, and the autonomous robot is configured to load or unload pallets from the trailer.

19. The autonomous robot of claim 13, the steps further comprising dynamically reactivating at least a front portion of the safety field of the autonomous robot during loading or unloading of a pallet inside the confined space.

20. The autonomous robot of claim 13, the steps further comprising dynamically reactivating at least a side portion of the safety field of the autonomous robot during a side shift operation inside the confined space, in which the autonomous robot laterally shifts a fork to align with pockets of a pallet.
